(19) United States
(12) Patent Application Publication
(10) Pub. No.: US 2017/0206339 A1
(43) Pub. Date: Jul. 20, 2017

(54) METHOD AND DATA PROCESSING SYSTEM FOR DATA COLLECTION FOR A CLINICAL STUDY

(71) Applicant: SIEMENS HEALTHCARE GMBH, Erlangen (DE)

(72) Inventor: Rüdiger Bertsch, Erlangen (DE)

(21) Appl. No.: 15/327,870

(22) PCT Filed: Jul. 23, 2014
(86) PCT No.: PCT/EP2014/065837

§ 371 Date: Apr. 5, 2017

(51) Int. Cl. G06F 19/00

(52) U.S. Cl. CPC G06F 19/363; G06F 19/324

(57) ABSTRACT

A method and data processing system for data collection for a clinical study is provided. A study management unit compares a test data record containing demographic and clinical data on at least one patient for a match with specified qualification criteria for the clinical study. If there is a match, a clinical treatment planned for the patient is compared with a study compliant treatment model. If there is a sufficient match, in interaction with the study management unit, a doctor treating the patient adapts the planned clinical treatment to fit the treatment model. Treatment data resulting from the adapted treatment is transmitted to the study management unit.

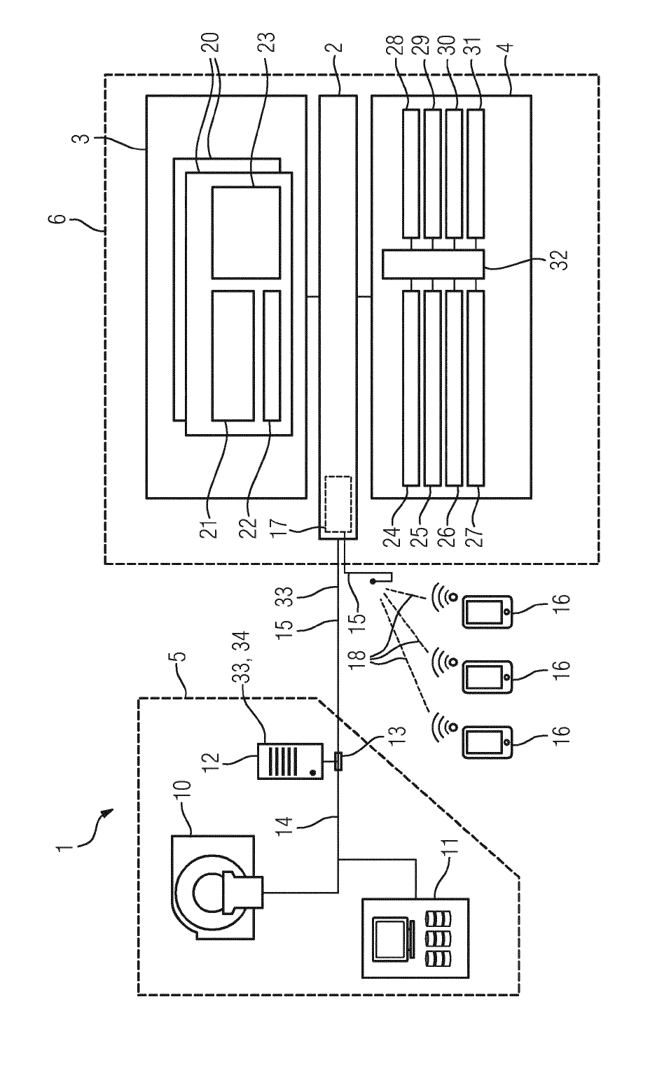

The invention relates to a method for data collection for a clinical study. The invention also relates to a data processing system for performing the method.

Collecting data for clinical studies is traditionally a time-consuming and labor-intensive process and therefore associated with significant costs. What is particularly time-consuming and expensive in this process is finding potential study participants (“crowd sourcing”), i.e. those patients whose data is used in the study. In particular, it is very difficult to identify statistically significant groupings of patients that satisfy the specific requirements of the particular study.

To find the study participants, a large number of attributes must routinely be checked and correlated. For studies in which medical imaging examinations need to be carried out, additional steps must also be taken to standardize the image acquisition and image analysis and thereby ensure the comparability of the image data acquired for different study participants. For example, a medical study usually requires the use of specified equipment, acquisition protocols and analysis algorithms. This necessitates regular harmonization of workflows between different clinics taking part in the study. In cases in which these alignments cannot be made or cannot be made early enough, the resultant treatment data often cannot be used for ongoing medical studies. Thus there is a significant level of wasted potential for data collection in clinical studies.

In addition, statutory data protection regulations, which prohibit clinics from giving out what is known as “protected health information” (or PHI data for short), make it considerably harder to collect data for a clinical study and in particular to select suitable participants. These data protection regulations mean that the search for suitable study participants can often only take place within the individual clinics, and thus separately for each individual clinic, which severely curtails the efficiency of “crowd sourcing”.

The object underlying the invention is to allow particularly efficient data collection for a clinical study.

With regard to a method for data collection for a clinical study, this object is achieved according to the invention by the features of claim 1. With regard to a data processing system for data collection for a clinical study, the object is achieved according to the invention by the features of claim 8. The dependent claims and the description below present advantageous embodiments and developments of the invention, some of which are inventive in their own right.

The method according to the invention is performed in an automated manner by means of a data processing system, i.e. by means of an arrangement of data processing devices (computers) that are interconnected by a data communications network and on which software designed to perform the method is implemented in executable form.

The data processing system used to perform the method according to the invention comprises a central study management unit and at least one (local clinical) data collection system.

“Local” means here that the data collection system is positioned at the location of the data collection, namely in a medical facility (in particular a clinic). Since a number of medical facilities are normally involved in the data collection for a clinical study, in an advantageous embodiment, the data processing system also comprises a corresponding number of such data collection systems.

Each data collection system in turn comprises a number of data processing devices (computers) that are interconnected by a data communications network and on each of which is implemented software. Each data collection system is typically established in the information technology architecture (IT architecture), in particular in a local area network (LAN), of the particular medical establishment. In an advantageous embodiment of the invention, each data collection system comprises at least one imaging modality (i.e. a medical imaging apparatus such as e.g. a computed tomography machine) and at least one information system, e.g. a radiology information system (RIS) and/or a hospital information system (HIS).

Said information system usually comprises one or more data storage devices, one or more associated data servers, at least one relational database, which is implemented in a database server, and, if applicable, one or more additional servers, in which are implemented methods for database access and data processing.

The central study management unit is again formed by one or more data processing devices (hardware servers) on which software is implemented. In principle, the invention allows said study management unit to be positioned at the location of a medical facility, in particular a clinic. Preferably, however, the central study management unit is implemented at a spatial separation from the medical facilities participating in the study, as part of a “cloud”.

A “cloud” is understood to mean a data processing facility that is provided and operated by a “cloud vendor” who is independent of the user. The cloud vendor typically provides the hardware and, if applicable, the software, of the cloud to a multiplicity of users as a service as part of a usage agreement (subscription). The following classifications are used according to the scope of the services provided:
an “Infrastructure as a Service” (IaaS) usage model, in which the user is provided only with computer hardware (computers, networks and memories) from the cloud, while the user is personally entirely responsible for the software operated in the cloud;
a “Platform as a Service” (PaaS) usage model, in which the user is offered from the cloud the computer hardware together with a programming and runtime environment that is created thereon, so that the user is personally responsible only for the application software (applications) implemented in this programming and runtime environment; and
a “Software as a Service” (SaaS) usage model, in which the user is also provided additionally with certain application software from the cloud.

There is also an additional classification according to the user group that the particular cloud is addressing:
a “public cloud”, whose services everyone can use, in particular globally; and
a “private cloud”, which is only accessible to users from a specific organization, in particular a specific company.

Based on these definitions, the study management unit is preferably implemented in a public cloud. In principle, however, the invention also allows the study management unit to be operated in a private cloud. The functions of the study management unit are preferably provided as “Software as a Service” to the commissioners of a medical study and to the medical facilities participating in the data collection.

In the method according to the invention, the study management unit compares a test data record of at least one patient for a match with qualification criteria for the medical study.

Said test data record contains demographic and clinical data on the patient, e.g. information on the age, gender, origin, domicile, nationality and/or marital status. The clinical data on the patient comprises, for example, details on the weight, blood pressure, size, admission, known pre-existing conditions, prior treatments, medical indications and/or medications. The, or each, test data record is provided to the study management unit preferably by those medical facilities in which the patient is treated (as an in-patient or out-patient) by means of the local data collection system there. In an advantageous embodiment of the method, a plurality of medical facilities supply a multiplicity of such test data records to the study management unit.

The qualification criteria that are used to compare the, or each, test data record contain all the information that is needed to identify suitable participants for the clinical study concerned. Said qualification criteria preferably comprise at least one inclusion criterion. The, or each, “inclusion criterion” here specifies an attribute that the particular patient must satisfy (positively) in order to be suitable for participation in the study. In addition, the qualification criteria optionally also contain one or more exclusion criteria. In this case, the, or each, “exclusion criterion” specifies an attribute that potential study participants must not have.

If the result of the comparison performed by the study management unit is that the test data record matches the qualification criteria of the study, the study management unit compares a clinical treatment planned for the patient concerned with a study-compliant treatment model.

The term “treatment” here includes in particular the use of one or more examination methods on the patient, in particular the acquisition of medical image data by means of a specific modality.

The planned clinical treatment, preferably together with the test data record or as part of said record, is also provided by the local clinical data collection system. The study-compliant treatment model, on the other hand, is provided to the study management unit preferably in a study specification, together with the qualification criteria or as part of said criteria.

In order to simplify finding suitable study participants and to increase the number of patients suitable for this study, the study-compliant treatment model is advantageously divided into at least one core aspect and at least one subsidiary aspect. The core aspect(s) form here what is basically a coarse grid that allows pre-sorting of potentially suitable candidates. Individual treatment steps or parameters are defined as subsidiary aspects, in which differently planned treatments can be adapted systematically, in particular without serious medical impact on the original objective of the planned treatment, to fit the study-compliant treatment model.

Thus in an advantageous embodiment of the invention, a specific treatment method, for example an imaging examination using a specific imaging modality, a body region to be examined and/or, if applicable, a specific orientation of the image acquisition, is provided as a core aspect of the study-compliant treatment model. Examples of defined core aspects of a treatment model are a chest (thorax) radiograph in anteroposterior projection or an abdominal computed tomography scan (CT scan).

As subsidiary aspects of the treatment model are defined, in particular, image acquisition parameters such as e.g.
for X-ray based image acquisition, data on the acquisition time, X-ray voltage, X-ray current or filtering;
for an MRI scan, data on MR sequences.

For the case in which it is established in the comparison described above that the planned treatment matches the study-compliant treatment model in the, or each, core aspect, but differs from the treatment model in the subsidiary aspect (or for a plurality of subsidiary aspects, in at least one of said aspects), the study management unit makes a request, for example by means of an automatically generated email, to a doctor treating the patient. In the request, the doctor performing the treatment is advised of the possibility of adapting the planned treatment in one or each differing subsidiary aspect to fit the treatment model.

The doctor can consent to this request, for example by sending back an appropriate pre-prepared reply email to the study management unit, or gives positive confirmation of his consent by other means, for example by activating a relevant link. In this case, the patient undergoes the treatment that has been adapted to the treatment model. For this purpose, for example, the local data collection system adapts a workflow characterizing the planned treatment of the patient to fit the treatment model.

All or at least some of the treatment data on the patient, in particular medical image data, which the local data collection system collects during the adapted treatment, is transmitted by the local data collection system to the study management unit. The study management unit provides all or some of the transmitted treatment data to a commissioner of the study.

The personal data on the patient, in particular the transmitted treatment data, is here preferably provided to the commissioner in de-identified form. This means that in the data provided to the commissioner, all data content from which the patient would be personally identifiable (e.g. name, exact date of birth, address, etc.) is suppressed or disguised.

In an advantageous embodiment of the method, the consent of the patient is sought by the study management unit in an automated manner before the patient is included as a study participant. For this purpose, before the study management unit adapts the planned treatment to fit the study-compliant treatment model, a request, again for instance by email, text message, etc., is made to the patient, in which request the patient is informed of the opportunity to participate in the study. In this case, the planned treatment is only adapted to fit the study-compliant treatment model, and also the treatment data is only transmitted to the study management unit, when the patient consents to the request, for example by sending back a signed participation declaration, a pre-prepared reply email or by sending back a specific text message, etc.

The patient and/or the doctor performing the treatment are informed as part of the relevant request preferably by the study management unit about the purpose of the study, the information and actions required of them and/or of the medical facility, any risks associated with participation in the study, and remuneration paid for participation in the study.

In a preferred embodiment of the invention, the request made to the patient is combined with the previously described request to the doctor performing the treatment by the doctor being asked in the request by the study management unit to obtain the consent of the patient.

The test data record provided to the study management unit preferably does not contain any personal protected health information (PHI data) on the patient. In this case, the test data record is preferably created within the local data collection system from the demographic and clinical data on the patient that is available there, with the PHI data being filtered out of this data. The PHI data excluded from the test data record may here be defined differently according to the national data protection regulations at the location of the local data collection system. Thus in an optional embodiment of the invention, in particular also different data collection systems arranged at different locations can exclude differently defined PHI data from inclusion in the test data record. In an advantageous embodiment of the invention, however, that data that is defined as protected health information under the US Health Insurance Portability and Accountability Act (HIPAA) is in particular excluded from the test data record. This data includes:
the name of the patient;
geographical origin or domicile information that is more specific than counties or comparable regions;
details of time intervals that are shorter than years;
phone numbers, fax numbers, email addresses, social security numbers, medical file numbers, health insurance numbers, account numbers, certificate/license numbers, vehicle registrations, Web addresses, IP addresses or other identification numbers which identify the patient as an individual;
biometric identification features (such as, for example, retina patterns or fingerprints); and
portrait photos or comparable pictures.

The test data record preferably contains, however, an identification code generated in compliance with the HIPAA, which is assigned to the test data record when it is created within the local clinical data collection system in order to allow the test data record to be traced back to the associated individual patient within the data collection system.

Any PHI data on the patient that is needed to carry out the study is transmitted to the study management unit preferably only once the patient has consented to the participation request (and hence to data dissemination).

The data processing system according to the invention is designed operationally to perform automatically the method described above. For this purpose, it comprises as a central component the aforementioned study management unit, preferably implemented as part of a cloud. With regard to the operational design of the data processing unit and to the preferred variants of this operational design, reference is made mutatis mutandis to the above embodiments of the method according to the invention and the embodiment variants of said method.

In order to provide an effective guarantee that data transmission between the, or each, local data collection system and the central study management unit is secure against misuse and complies with data protection regulations, the data processing system preferably comprises an interface unit. The interface unit is provided as part of the, or each, local data collection system, and acts as a (local) interface for data transmission between the local data collection system and the study management unit. The interface unit is designed in this case to create from the demographic and clinical data on the patient, which is available in the local clinical data collection system, the test data record, to be forwarded to the study management unit, in such a way that the test data record does not contain any PHI data. For, or if applicable with, consent of the patient, the interface unit guarantees encrypted transmission. Symmetric schemes (e.g. AES, DES or 3DES) or asymmetric schemes (e.g. RSA) can be used for this purpose, with a key length being selected that is sufficient for compliance with data protection regulations. For example, the encryption is performed in accordance with 256-bit AES or 2048-bit RSA.

The data processing system preferably also comprises a study requirements database and/or a study data database as additional central components. Said study requirements database contains the qualification criteria for the medical study and the study-compliant treatment model. In the study data database, on the other hand, are archived all the demographic and clinical data and all the treatment data on the patient. At the very least, any PHI data on the patient is in this case stored in the study data database preferably in a sufficiently encrypted form to comply with data protection regulations.

The study requirements database and/or the study data database are preferably implemented as part of a cloud.

An exemplary embodiment of the invention is described in greater detail below with reference to a drawing, in which the single FIGURE is a block diagram showing in a simplified outline view a (data processing) system 1 for data collection for a clinical study.

The system 1 comprises as central elements a study management unit 2, a study requirements database 3 and a study data database 4. In addition, the system 1 comprises a multiplicity of local clinical data collection systems 5, of which only one is shown for the sake of clarity.

The central components of the system 1, i.e. the study management unit 2, the study requirements database 3 and the study data database 4, are each formed by data-processing hardware on which software is running, and as such are implemented as part of a public cloud 6. As part of the system 1, the service offered by the Microsoft company under the name “Windows Azure” is used, for example, as the public cloud 6. As an alternative, however, a different public cloud or a combination of a plurality of public clouds (if appropriate also from different cloud vendors) can be used in the context of the invention.

The data collection systems 5 are each locally established at the location of a clinic, each forming an element of the IT architecture of the clinic. Each clinic potentially participating in the data collection for clinical studies as part of the system 1 is thus assigned a dedicated data collection system 5.

In accordance with the usual IT architecture of a modern clinic, each data collection system 5 comprises a number of medical imaging modalities 10 and a number of information systems 11. A computed tomography machine is shown by way of example in the FIGURE as the one modality 10. As information systems 11, the data collection system 5 comprises, for example, a radiology information system (RIS) and what is known as a picture archiving and communication system (PACS).

Unlike the IT architecture of a typical clinic, each data collection system 5 additionally comprises an interface unit 12. Said interface unit 12 is designed to organize the data transfer between the associated data collection system 5 and the study management unit 2, and in particular in the process to protect the personal data of study participants from unauthorized access by third parties. The interface unit 12 can be embodied as an autonomous device having dedicated hardware and software. The interface unit 12 may also be a pure software element, however, which runs on a hardware server of the information system 11, on a firewall 13 or another hardware element of the IT architecture of the associated clinic.

Within the data collection system 5, and thus within the associated clinic, a local area network (LAN) 14 is used to provide a data communications interconnection between the, or each, modality 10, the, or each, information system 11 and the interface unit 12. The Internet 15 is used as the data communications connection between the data collection system 5 and the cloud-based study management unit 2.

In order to be able to exchange data not only with the, or each, interface unit 12 but also with other Internet-compatible communications devices 16, the study management unit 2 also provides a Web portal 17 that can be accessed via the Internet 15.

The communications devices 16 may be, as shown by way of example in the FIGURE, smartphones or tablet computers, which have a data communications connection to the public cloud 6 and to the study management unit 2 therein via a cellular (wireless) Internet connection 18. As an alternative, however, a computer that has a wired connection to the Internet 15 and on which an Internet browser is installed in executable form can be used as the communications device 16.

A number of study specifications 20 are stored in the study requirements database 3. A study specification 20 here denotes a collection of data, where each study specification 20 is assigned to a clinical study to be carried out and contains all the information needed to collect data for the associated study, in particular for identifying suitable study participants.

Specifically, each study specification 20 contains a collection of qualification criteria 21, which specify inclusion criteria and/or exclusion criteria for participation of a patient in the study concerned in accordance with the above definitions. In terms of the more detailed definition given above, these criteria relate to demographic and clinical data on the patient.

In addition, the study specification 20 contains at least one study-compliant treatment model 22, which specifies an imaging examination to be performed as part of the study in terms of the type of modality 10 to be used, the body region of interest (in particular organ of interest) of the patient, if applicable the projection of the image acquisition, and other image acquisition parameters (for an X-ray examination e.g. X-ray voltage, X-ray current, filtering, acquisition time, etc.). In said treatment model 22 is defined at least one core aspect, which is fundamental in determining whether the planned treatment can be used in the present study (for example details about the nature of the planned examination method and the organ to be imaged). Also defined in the treatment model 22 is at least one subsidiary aspect in which a planned treatment can potentially be adapted in order to make the treatment compatible with the study.

In addition, each study specification 20 contains a collection of information (referred to below as study information 23) regarding the purpose of the study, the actions to be performed by the participating patient and/or the doctor performing the treatment, and the remuneration set for participation in the study for the participating patient and/or the participating clinic.

In the study data database 4 is archived the data collected on each study participant (i.e. participating patient) for the study, specifically PHI data 24 as defined above, image data records 25 for the medical images acquired for the study, findings 26 reported by the clinic on the basis of the analysis of the study-compliant treatment of the patient, and optional personal observations 27, which are reported by the actual study participant and relate to the study-compliant treatment.

In the study data database 4 are also stored for each study participant:
information on access permissions 28, which detail which users of the study management unit 2 can access what specific personal data in the study data database 4 (i.e. in particular the PHI data 24, the image data 25, the findings 26 or the personal observations 27);
statements and documents (referred to below for short under the term participant consent 29), which document the consent of the particular patient to participation in the study;
information on the audit trailing 31 of the system 1, in particular reports, which log every data access (when, by whom, what is changed); and
information on (technical) transactions 32, in particular on the supply, processing and retrieval of information.

Within the study data database 4, the data content listed above (i.e. the PHI data 24, the image data 25, the findings 26, the personal observations 27, the access permissions 28, the participant consent 29, the audit trailing 30 and the transactions 31) are linked to one another by association with a common participant identification code 32. Said participant identification code 32 is selected such that it cannot be used by an outsider to find out anything about the identity of the study participant.

At the very least, the PHI data 24, which would at least potentially allow identification of the individual study participant, is archived in the study data database in strongly encrypted form. Preferably, however, all the other data contents of the study data database 4 are also archived in encrypted form.

During operation of the system 1, the interface unit 12 continuously scans the data collected in the associated data collection system 5 on patients newly admitted to the clinic.

From this data, the interface unit 12 produces for each newly admitted patient to the clinic (alternatively for pre-selected patients) the corresponding test data record 33, and transmits this record to the study management unit 2.

Said test data record 33 contains demographic data on the patient, such as age and gender, for example. The test data record 33 also contains clinical data on the patient, specifically an admissions report and details of the blood pressure and medication of the patient. Finally, the test data record 33 contains information on a treatment of the patient planned by the clinic (specifically information about a planned imaging examination of the patient). The interface unit 12 here ensures that the test data record 33 does not contain any PHI data on the patient that must be handled confidentially. If such PHI data was contained in the patient data originally collected in the data collection system 5 (for example as meta data), then the interface unit 12 deletes or disguises this PHI data in the test data record 33.

In addition, the interface unit 12 generates as part of the test data record 33 the corresponding participant identification code 32. In order to allow the test data record 33 to be traced back to the individual patient, the interface unit 12 generates internally an association 34, which associates the participant identification code 32 with the patient ID of the patient, which ID is issued in the data collection system 5. For data protection reasons, however, this association 34 is archived solely within the interface unit 12 in a manner that is neither visible nor extractable from outside. This ensures that it is only possible for the interface unit 12 to associate the generated test data record 33 with the corresponding individual patient.

The study management unit 2 compares the transmitted test data record 33 with the qualification criteria 21 stored for each study specification 20.

If the study management unit 2 establishes for each study specification 20 that the test data record 33 infringes the qualification criteria 21 contained in that particular study specification, it discards (deletes) the test data record T. Elsewise, i.e. if the study management unit 2 establishes that the test data record 33 matches the qualification criteria 21 of one of the study specifications 20, the study management unit 2 compares, in a next step, the information on the planned treatment, which information is contained in the test data record 33, with the treatment model 22 of this study specification 20.

If in this comparison the study management unit 2 establishes that the planned treatment differs from the treatment model 22 in a core aspect, it again discards the test data record T. Elsewise, if it establishes that the planned treatment matches the treatment model 22 in the, or each, core aspect, but differs from the treatment model in at least one subsidiary aspect, it determines those treatment steps or parameters in which the planned treatment would have to be changed in order to fit the treatment model 22. This step is obviously dispensed with if the study management unit 2 establishes that the planned treatment matches the treatment model 22 in all core aspects and subsidiary aspects.

In the two last-mentioned cases, i.e. when the planned treatment matches the treatment model 22 at least in the, or each, core aspect, the study management unit 2 automatically generates a request, in which the patient and the associated clinic are informed about the opportunity to participate in the study concerned. The request contains in particular:
a pre-prepared declaration of consent by the patient to participation in the study;
a pre-prepared declaration of consent by the clinic to participation in the study;
if applicable, information on the treatment steps and parameters in which the planned treatment would have to be changed in order to fit the study-compliant treatment model 22; and
further information on the purpose of the study, the actions expected of the clinic and of the patient, any risks and the remuneration linked to participation for the patient and the clinic; the study management unit obtains this additional information from the study information 23.

The study management unit 2 sends the request to the interface unit 12, which uses the internal association to correlate this request with the corresponding individual patient, and directs this request, for example using an automatically generated email, to the doctor performing the treatment on the patient.

The doctor can now first decide from the information contained in the request whether in his opinion it is possible for the patient to take part in the study, in particular whether any requested change to the planned treatment is acceptable in light of the personal medical situation of the patient.

If the doctor answers this with a negative, the doctor declines participation in the study by suitable notification, which is fed back to the study management unit 2 via the interface unit 12, whereupon the study management unit 2 terminates the process. Elsewise, the doctor presents to the patient the proposal to participate in the study.

The patient can now on his part decline participation in the study, whereupon the process is again terminated. Alternatively, the patient may consent to participation in the study by signing the pre-prepared declaration of consent. In this case, the declaration of participation is fed back via the interface unit 12 to the study management unit 2, which saves said declaration in the study data database 4.

If the participant consent 29 exists after this process, the study management unit 2 asks the patient and/or the associated clinic to supply subsequently, if necessary, demographic and/or clinical data on the patient that is needed for participation in the study but was not yet included in the test data record 33. This subsequently requested information typically contains also PHI data on the patient, in particular the name of the patient, patient ID, email address, etc.

Subsequently, the clinic carries out the treatment on the patient, which treatment has been adapted to fit the treatment model 22. The image data 25 generated as treatment data in this process is transmitted by the interface unit 12, again in a form cleaned of PHI data, to the study management unit 2, which stores this data in the study data database 4. Concomitant with the treatment are transmitted to the study management unit 2 from the doctor performing the treatment the findings 26 obtained from the treatment, and from the patient the personal observations 27 by the patient, and the study management unit saves said information in the study data database 4. The findings 26 and the personal observations 27 can in this case be transmitted to the study management unit 2 optionally either by means of the data collection system 5 and the interface unit 12 or using the communications devices 16 and the Web portal 17.

The study management unit 2 provides the data contained in the study data database 4 to the commissioner of the study. In providing this data, the study management unit 2 takes into account the access permissions 28 to ensure that the commissioner of the study is provided only with that data for which the patient has given consent to be disseminated.

The interaction between the study management unit 2 and the interface unit 12 ensures that the study management unit 2 is supplied with protected PHI data 24 on the patient only once the patient has given consent. In addition, the interface unit 12 and the study management unit 2 ensure that in particular the PHI data, but preferably any personal data on the patient, is transmitted and archived in strongly encrypted form.

### CASE EXAMPLE

In the following example intended to clarify the operation of the above-mentioned system 1, it shall be assumed that the study requirements database 3 contains a study specification 20 for a study that is interested in male patients aged between 40 and 55, weighing between 60 and 75 kg, having high blood pressure and a specific medication, with two other specific medications being explicitly excluded. According to the associated study information 23, the purpose of the study is to collect data on the size of the liver of these patients.

A patient called John Smith is admitted to a specific clinic as a result of a sports injury. The doctor treating the patient arranges an abdominal computed tomography scan (CT scan) as a planned treatment. On admittance to the clinic, the age, weight, blood pressure and medication details of the patient John Smith are recorded in the (radiology) information system 11 of the clinic. From this data, the interface unit 12 assigned to the clinic creates the corresponding test data record 33, which test data record 33 in particular does not contain the name of the patient, which is protected as PHI, and transmits this test data record 33 to the study management unit 2.

By comparing the test data record 33 with the qualification criteria 21 and the treatment model 22 of the study specification 20, the study management unit 2 identifies John Smith as a potential study participant, specifically since
all inclusion criteria contained therein (age, weight, blood pressure, required medication) are satisfied; and
the abdominal CT scan intended as the planned treatment includes imaging the liver, thereby fulfilling the single core aspect of the treatment model 22.

The study management unit 2 now analyses the parameters of the imaging protocol created as part of the planned treatment, and identifies parameters that would need to be changed in order to fit the planned treatment to the treatment model 22 by adapting differing subsidiary aspects.

Thereupon, the study management unit 2 transmits the request to the doctor performing the treatment, in which request the doctor is informed that John Smith has been identified as a potential study participants. In the request, the doctor is also asked to:
provide details of the medications excluded as exclusion criteria; and
to check whether the proposed changes to the imaging protocol are acceptable from a medical viewpoint.

In this process, the doctor is provided with the background information on the study, which information is contained in the study information 23, in order to be able to inform John Smith accordingly.

Then the doctor transmits back to the study management unit 2 via the interface unit 12:
the missing information on the exclusion criteria of the study;
the consent of the clinic to adapt the planned treatment to fit the treatment model 22; and
the signed declaration of consent of the patient John Smith.

If the exclusion criteria are also satisfied, the study management unit 2 then registers the patient John Smith as a study participant and provides both the patient John Smith and the doctor with access via the Web portal 17 that can be used by John Smith and/or the doctor to answer further questions and to transmit personal observations 27 and/or findings 26 to the study management unit 2.

Inside the clinic, the patient John Smith now undergoes the treatment adapted to fit the treatment model 22, i.e. the adapted abdominal CT scan. For this purpose, the acquisition protocol of the modality 10 is adapted accordingly prior to image acquisition.

The acquired image data 25 and the details of the adapted image acquisition protocol are sent automatically by the interface unit 12 to the study management unit 2, with the interface unit 12 automatically removing PHI data 24 on the patient from this data. The study management unit 2 stores the transmitted data in the study data database 4.

If the PHI data 24 on the patient is needed in the study, the interface unit 12 strongly encrypts said data and transmits said data solely in this form to the study management unit 2.

The doctor makes a diagnosis from the acquired image data 25 on the basis of the admissions report (sports injury). In addition, the doctor analyzes the image data in accordance with the study requirement (determining the liver size). The doctor transmits the results of this study-relevant analysis via the Web portal 17 to the study management unit 2, which archives these results in the study data database 4.

For his participation in the study, John Smith receives a remuneration, the payment of which is managed by the study management unit 2. In addition, the clinic also receives a remuneration for its participation in the study and for the additional analysis performed as part of the study, which remuneration is likewise managed by the study management unit 2.

Furthermore, the study management unit 2 informs the commissioner of the study that new data has been collected and interpreted for the study, and allows the commissioner of the study access to the de-identified data (i.e. data cleaned of the PHI data 24) on the patient John Smith. The study management unit 2 optionally provides the commissioner of the study with further algorithms for further analysis of the study.

To summarize, a method for data collection for a clinical study is defined. In addition, a data processing system 1 for performing the method is defined, which comprises a central study management unit 2 and at least one local clinical data collection system 5. The study management unit 2 is used to compare a test data record 33 containing demographic and clinical data on at least one patient for a match with specified qualification criteria 21 for the medical study. If there is a match, a clinical treatment planned for the patient is compared with a study-compliant treatment model 22. If there is a sufficient match, in interaction with the study management unit 2, a doctor treating the patient adapts the planned clinical treatment to fit the treatment model 22. Treatment data 25 resulting from the adapted treatment is transmitted to the study management unit 2.

The exemplary embodiment described above, while making the invention particularly clear has no limiting effect on the invention. Indeed, other embodiments of the invention can be derived from the claims and the description above.

### LIST OF REFERENCES

1 (data processing) system
2 study management system
3 study requirements database
4 study data database
5 data collection system
6 public cloud
10 modality
11 information system
12 interface module
13 firewall
14 LAN
15 Internet
16 communications device
17 Web portal
18 cellular Internet connection
20 study specification
21 qualification criteria
22 treatment model
23 study information
24 PHI data
25 image data
26 findings
27 personal observations
28 access permissions
29 participant consent
30 audit trailing
31 transactions
32 participant identification code
33 test data record
34 association

1. A method for data collection for a clinical study by means of a data processing system (1), which comprises a central study management unit (2) and at least one local clinical data collection system (5),
wherein the study management unit (2) compares a test data record (33) containing demographic and clinical data on at least one patient for a match with defined qualification criteria (21) for the medical study,
wherein, if the test data record (33) matches the qualification criteria (21) of the study, the study management unit (2) compares a clinical treatment planned for the patient with a study-compliant treatment model (22), wherein at least one core aspect and at least one subsidiary aspect are defined with regard to the treatment model (22),
wherein, if the planned clinical treatment matches the treatment model (22) in the, or each, core aspect, and differs from the treatment model (22) in the subsidiary aspect or in at least one of the subsidiary aspects, the study management unit (2) makes a request to a doctor treating the patient to adapt the planned clinical treatment in one or each subsidiary aspect to fit the treatment model (22),
wherein, if the doctor consents to the request, the patient undergoes the treatment that has been adapted to the treatment model (22), wherein the local clinical data collection system (5) collects treatment data (25) on the patient and transmits all or some of said treatment data to the study management unit (2).

2. The method as claimed in claim 1,
wherein the study management unit (2) makes a request to the patient to participate in the study, and wherein the planned treatment is only adapted to fit the treatment model (2), and the treatment data (25) is only transmitted to the study management unit (2), when the patient consents to the request.

3. The method as claimed in claim 2,
wherein the test data record (33) provided to the study management unit (2) does not contain any PHI data (24), and wherein PHI data (24) is transmitted to the study management unit (2) only once the patient has consented to the request.

4. The method as claimed in one of claims 1 to 3,
wherein a specific medical imaging examination method is defined as a core aspect of the treatment model (22).

5. The method as claimed in one of claims 1 to 4,
wherein a specific stipulation for the setting of an image acquisition parameter is defined as a subsidiary aspect of the treatment model (22).

6. The method as claimed in one of claims 1 to 5,
wherein the treatment data (25) comprises at least one medical image data record.

7. The method as claimed in one of claims 1 to 6,
wherein the study management unit (2) is implemented as part of a cloud (6).

8. A data processing system (1) for data collection for a clinical study, comprising a central study management unit (2) and comprising at least one local clinical data collection system (5), wherein the study management unit (2) is designed
to compare a test data record (33) containing demographic and clinical data on at least one patient for a match with defined qualification criteria (21) for the medical study,
if the demographic and clinical data on the patient matches the qualification criteria (21), to compare a clinical treatment planned for the patient with a study-compliant treatment model (22), wherein at least one subsidiary aspect and at least one subsidiary aspect are defined with regard to the treatment model (22),
if the planned clinical treatment matches the treatment model (22) in the, or each, core aspect, and differs from the study-compliant treatment model (22) in the subsidiary aspect or in at least one of the subsidiary aspects, to make a request by means of the study management unit (2) to a doctor treating the patient to adapt the planned clinical treatment in one or each core aspect to fit the treatment model (22),
if the doctor performing the treatment consents to the request, to arrange for the treatment that has been adapted to the treatment model (22) to be performed on the patient, and
to transmit to the study management unit (2) all or some of the treatment data (25) on the patient that has been collected by the local clinical data collection system (5) during the adapted treatment.

9. The data processing system (1) as claimed in claim 8,
wherein the study management unit (2) is designed to make a request to the patient to participate in the study, and to arrange for the planned treatment to be adapted to fit the treatment model (2) only once the patient consents to the request.

10. The data processing system (1) as claimed in claim 8 or 9, comprising an interface unit (12), which acts as an interface for data transmission between the local clinical data collection system (5) and the study management unit (2), wherein the interface unit (12) is designed to create from the demographic and clinical data on the patient, which is available in the local clinical data collection system (5), the test data record (33), for forwarding to the study management unit (2), in such a way that the test data record (33) does not contain any PHI data.

11. The data processing system (1) as claimed in claim 10,
wherein the study management unit (2) is designed to ask for PHI data (24) required for the study only once the patient has consented to the request.

12. The data processing system (1) as claimed in one of claims 8 to 11, wherein the study management unit (2) is implemented as part of a cloud (6).

13. The data processing system (1) as claimed in one of claims 8 to 12, wherein the local clinical data collection system (5) comprises at least one medical engineering modality (10) for generating medical image data, and at least one information system (11) for managing the image data.

14. The data processing system (1) as claimed in one of claims 8 to 13, comprising a study requirements database (3), which contains the qualification criteria (21) for the medical study and the treatment model (22).

15. The data processing system (1) as claimed in claim 14,
wherein the study requirements database (3) is implemented as part of a cloud (6).

16. The data processing system (1) as claimed in one of claims 8 to 15, comprising a study data database (4), in which is archived the treatment data (25) on the patient transmitted to the study management unit (2).

17. The data processing system (1) as claimed in claim 16,
wherein the study data database (4) is implemented as part of a cloud (6).
